(19) United States
(12) Patent Application Publication
(10) Pub. No.: US 2002/0051287 A1
(43) Pub. Date: May 2, 2002

(54) Imaging apparatus for microscope

(75) Inventors: Tomohiro Uchida, Hachioji-shi (JP); Jitsunari Kojima, Hachioji-shi (JP); Shinichiro Aizaki, Ome-shi (JP)

Correspondence Address: FRISHAUF, HOLTZ, GOODMAN,, LANGER & CHICK, P.C., ATTORNEYS AT LAW, 767 THIRD AVENUE, NEW YORK, NY, 10017-2023, US

(73) Assignee: Olympus Optical Co., Ltd., Tokyo (JP)

(21) Appl. No.: 09/910,738

(22) Filed: Jul. 23, 2001

(30) Foreign Application Priority Data
Jul. 25, 2000 (JP) 2000-224344
May 23, 2001 (JP) 2001-153842

(51) Int. Cl. G02B 21/00

(52) U.S. Cl. 359/368

(57) ABSTRACT

The imaging apparatus for a microscope, according to the present invention, comprises an imaging section which picks up an observation image of a sample formed in a microscope body, an imaging apparatus body having the imaging section, a display section which displays image data corresponding to the observation image picked up by the imaging section, and an operation section which performs operation of the imaging section, wherein the imaging apparatus body and the display section are separate from each other.

### CROSS-REFERENCE TO RELATED APPLICATIONS

This application is based upon and claims the benefit of priority from the prior Japanese Patent Applications No. 2000-224344, Jul. 25, 2000; and No. 2001-153842, May 23, 2001, the entire contents of which are incorporated herein by reference.

### BACKGROUND OF THE INVENTION

1. Field of the Invention

The present invention relates to an imaging apparatus for a microscope, which picks up an image of a sample on the microscope.

2. Description of the Background Art

Various apparatuses have been developed as imaging apparatuses for microscopes. Japanese Patent Application KOKAI Publication No. 10-133125 discloses a microscopic photographing apparatus comprising a head section, which is provided on a light path of light emitted from a microscope and guides the light to a camera including a film for photographing, and an operation section for making operation of photographing an image of a sample obtained by a microscope. In this microscopic photographing apparatus, the operation section and the head part are constructed as separate components, and a cable for transmitting signals is provided between the head section and the operation section. In addition, the operation section can be attached to the head section. Further, in this microscopic photographing apparatus, the operation section and a shutter time display section are provided integrally. According to this structure, the operation section can be used properly in accordance with various use states.

Japanese Patent Application KOKAI Publication No. 11-271644 discloses an imaging apparatus for a microscope, comprising a variable-magnification optical system capable of changing a projection magnification at which a sample image from an objective lens to an imaging element, and a control section for controlling the magnification of the variable-magnification optical system. The optical system includes an imaging element for picking up a sample image from the objective lens, and a display section for displaying the sample image obtained by the imaging element. Further, the imaging section including the imaging element is connected with a display section for displaying the sample image. By this structure, framing to an aimed target can be achieved with a high magnification while watching the display section, without looking into the eyepiece of the microscope body, in the observation mode. In the photographing mode, a microscopic photograph with high resolution can be picked up.

Further, Japanese Patent Application KOKAI Publication No. 2000-83184 discloses an electronic camera for a microscope in which an electronic camera and a display section for displaying an image received by an imaging element of the electronic camera are provided integrally by applying an adaptor for a TV camera to the body of a microscope. By this structure, a digital photograph can be attained easily by a space-saving structure at a low price.

However, if the microscopic photographing apparatus disclosed in the publication No. 10-133125 is attached to a microscope of a large size equipped with various devices, if it is attached to a deep portion of a microscope having a great depth so that the camera is relatively far from the operational range of an observer, or if the distance between an observer and a microscope is long, the camera body, i.e., the display section and the operation section are so distant from the observer, that imaging operation and imaging images are difficult to confirm. Meanwhile, if the operation section is separated from the camera, imaging operation can be taken when there is a distance between the camera and the observer. However, focusing and framing are carried out by the camera body, so total imaging operation is difficult.

In the imaging apparatus for a microscope disclosed in the publication No. 11-271644, the control section and the display section are different from each other, so that operation and confirmation are complicated for the observer. Consequently, total imaging operation is difficult.

In the electronic camera for a microscope disclosed in the publication No. 2000-83184, the display section is integrally provided on an electronic camera. Therefore, confirmation of the display is difficult depending on the attachment condition of the electronic camera. In addition, the operation section and the display section are separated from each other, so that total imaging operation is complicated.

As explained above, in none of conventional imaging apparatuses for microscopes, the camera body having an imaging function is separated from the display section for confirming picked-up images focusing and framing.

In recent years, an electronic camera for a microscope, in which a sample image from a microscope is electrically imaged, has been widely used in the field of microscopes as digital techniques have been developed. An example of this kind of electronic camera for a microscope is disclosed in Japanese Patent Application KOKAI Publication No. 2000-83184.

FIG. 33 is a view showing the structure of a microscopic electronic camera system according to the conventional example. As shown in this figure, a microscopic electronic camera 300 is provided integrally with an imaging element 301, a signal processing part 302 for processing an imaging signal from the imaging element 301, a memory 303 for recording image data processed by the signal processing part 302, and a monitor 304 for displaying image data. This microscopic electronic camera 300 is attached to a microscope body 305 by a TV camera adaptor 306. By this structure, a system comprising the microscopic electronic camera 300 can be constructed at a low price, saving place, and framing and focusing at the time of photographing can be carried out easily at high precision.

However, this microscopic electronic camera 300 is provided integrally with the monitor 304, so that a monitor 304 having very high resolution cannot be used. Therefore, the resolution of an image displayed on the monitor 304 is degraded, compared with a sample image observed with eyes through the eyepiece of the microscope. There hence has been room for improvement in precision in focusing, framing, and the like.

As a method of solving this problem, consideration has been taken into a method of using a digital camera having an electronic zoom function. This kind of digital camera having an electronic zoom function has been widely spreading generally to photograph persons and landscapes and the like. By photographing with use of this electronic zoom function of a digital camera, a sample image of a desired size can be displayed on the monitor 304.

However, if this kind of digital camera is used, the image whose magnification has been converted by the electronic zoom function is recorded in the memory, so that a problem arises in that an image of lower resolution than the number of pixels of the imaging element is recorded.

### BRIEF SUMMARY OF THE INVENTION

The present invention has an object of providing an imaging apparatus for a microscope, which improves operation ability at photographing.

An imaging apparatus for a microscope, according to the present invention, comprises: an imaging section which picks up an observation image of a sample formed in a microscope body; an imaging apparatus body having the imaging section; a display section which displays image data corresponding to the observation image picked up by the imaging section; and an operation section which performs operation of the imaging section, wherein the imaging apparatus body and the display section are separate from each other.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view showing the structure of a microscope system to which an imaging apparatus for a microscope, according to an embodiment of the present invention, is applied;

FIG. 2 is a block diagram showing the structure of a camera head section according to the embodiment of the present invention;

FIG. 3 is a plan view showing the structure of a operation section according to the embodiment of the present invention;

FIG. 4 is a block diagram showing the structure of a display section according to the embodiment of the present invention;

FIG. 5 is a block diagram showing a modification of the camera head section and the operation display device according to the embodiment of the present invention;

FIG. 6 is a block diagram showing a modification of the display section according to the embodiment of the present invention;

FIG. 7 is a perspective view showing a modification of the operation display device according to the embodiment of the present invention;

FIG. 8 is a block diagram showing a modification of the memory device according to the embodiment of the present invention;

FIG. 9 is a block diagram showing the structure of an operation display device according to the embodiment of the present invention;

FIG. 10 is a block diagram showing a modification of the operation display device according to the embodiment of the present invention;

FIG. 11 is a block diagram showing a modification of the operation display device according to the embodiment of the present invention;

FIG. 12 is a perspective view showing the structure of an operation display device according to the embodiment of the present invention;

FIG. 13 is a block diagram showing a modification of the operation display device according to the embodiment of the present invention;

FIG. 14 is a perspective view showing a modification of the operation display device according to the embodiment of the present invention;

FIG. 15 is a partial cross-sectional view showing the structure of a support section and an installation section according to the embodiment of the present invention;

FIG. 16 is a view showing the structure of an imaging apparatus for a microscope and a microscope body according to the embodiment of the present invention;

FIG. 17 is a view showing the structure of a camera head section and an operation display section according to the embodiment of the present invention;

FIG. 18 a view showing the structure of an operation surface of an operation section according to the embodiment of the present invention;

FIG. 19 is a flowchart showing a procedure of operating the imaging apparatus for a microscope, according to the embodiment of the present invention;

FIG. 20 is a view showing an image of a sample according to the embodiment of the present invention;

FIGS. 21A, 21B, and 21C are views showing stored images and displayed images according to the embodiment of the present invention;

FIG. 22 is a flowchart showing a procedure of operating the imaging apparatus for a microscope according to the embodiment of the present invention;

FIGS. 23A, 23B, and 23C are views showing displayed images according to the embodiment of the present invention;

FIGS. 24A, 24B, 24C, 24D, 24E, and 24F are views showing stored images and displayed images according to the embodiment of the present invention;

FIGS. 25A, 25B, and 25C are views showing stored images and displayed images according to the embodiment of the present invention;

FIGS. 26 are views showing a stored image and displayed images according to the embodiment of the present invention;

FIGS. 27A, 27B, 27C, and 27D are views showing still-image recording ranges according to the embodiment of the present invention;

FIG. 28 is a view showing a displayed image according to the embodiment of the present invention;

FIG. 29 is a view showing a displayed image according to the embodiment of the present invention;

FIG. 30 is a view showing a displayed image according to the embodiment of the present invention;

FIG. 31 is a view showing a displayed image according to the embodiment of the present invention;

FIG. 32 is a perspective view showing a modification of the operation display section according to the embodiment of the present invention; and

FIG. 33 is a view showing the structure of a microscopic electronic camera system according to the prior art.

### DETAILED DESCRIPTION OF THE INVENTION

In the following, embodiments of the present invention will be explained with reference to the drawings.

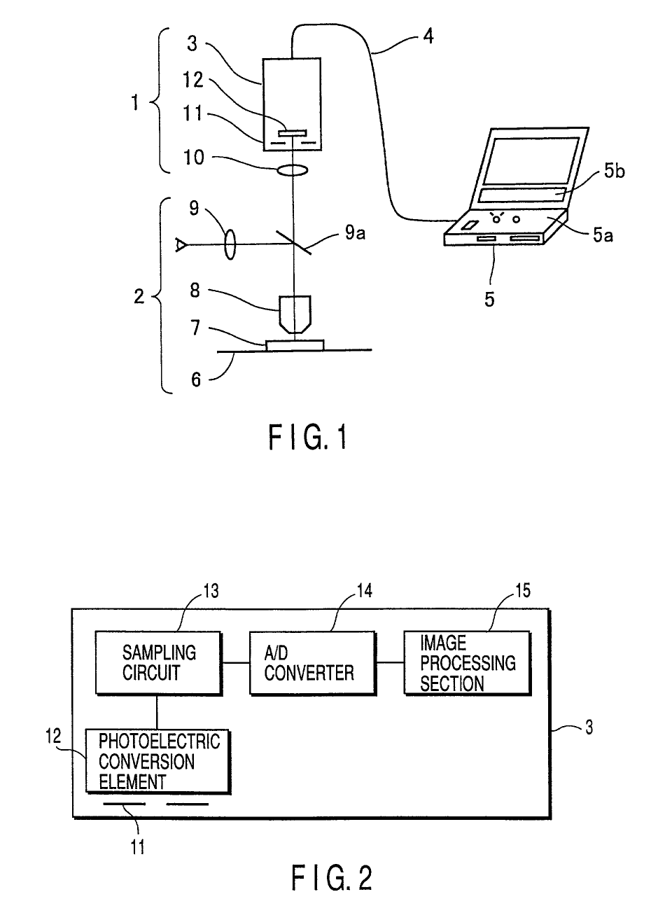

FIG. 1 is a view showing the structure of a microscope system to which an imaging apparatus for a microscope according to a first embodiment of the present invention is applied. An imaging apparatus body 1 is mounted on a microscope body 2. A digital camera head section 3 (hereinafter called a camera head section) of the imaging apparatus body 1 is provided on a light path of the light emitted from the microscope body 2. Further, the imaging apparatus body 1 has an operation display device 5 connected with the camera head section 3 by a cable 4.

The operation display device 5 includes an operation section 5a for operating the camera head section 3, and a display section 5b for displaying a sample image (an observation image of a sample) guided to the camera head section 3. The display section 5b not only displays a sample image but also has a function to display various imaging setting conditions and the like which are carried out by the operation section 5a. The camera head section 3 and the operation display device 5 are connected by the cable 4, so that electric signals can be transferred to and received from each other. Also, if the operation display device 5 is installed apart from the camera head section 3 within a range allowed by the length of the cable 4, photographing operation can be achieved.

Further, in the operation display device 5, the operation section 5a and the display section 5 are installed at an angle of substantial 90° to each other. Therefore, when the operation display device 5 is set on a desk, the operation section 5a is arranged substantially in parallel with the desk surface, and the display section 5b is arranged substantially at an angle of 90 degrees to the desk surface.

In the microscope body 2, an image is formed by an objective lens 8 to obtain a sample image, with respect to a sample 7 set on a stage 6. This sample image is guided to an eyepiece 9 through a half-mirror 9a. An observer can observe the sample image by looking into the eyepiece 9. The sample image is guided to a photoelectric conversion element 12 in the camera head section 3 by the imaging lens 10. A shutter 11 included in the camera head section 3 is provided above the imaging lens 10. Except the imaging lens 10, the sample image from the objective lens 8 may be formed directly on the photoelectric conversion element 12.

FIG. 2 is a block diagram showing the structure of the camera head section 3. The camera head section 3 includes a photoelectric conversion element 12 (e.g., charge coupling device (CCD)) for photoelectrically converting the sample image from the microscope body 2, a sampling circuit 13 for performing sampling on the basis of an electric signal supplied from the photoelectric conversion element 12, an A/D converter 14 for converting an analogue signal obtained from the sampling circuit 13 into a digital signal, an image processing section 15 for performing processing for reproduction on the basis of the converted digital signal, and the shutter 11 for shutting the optical image projected on the photoelectric conversion element 12 at a desired time.

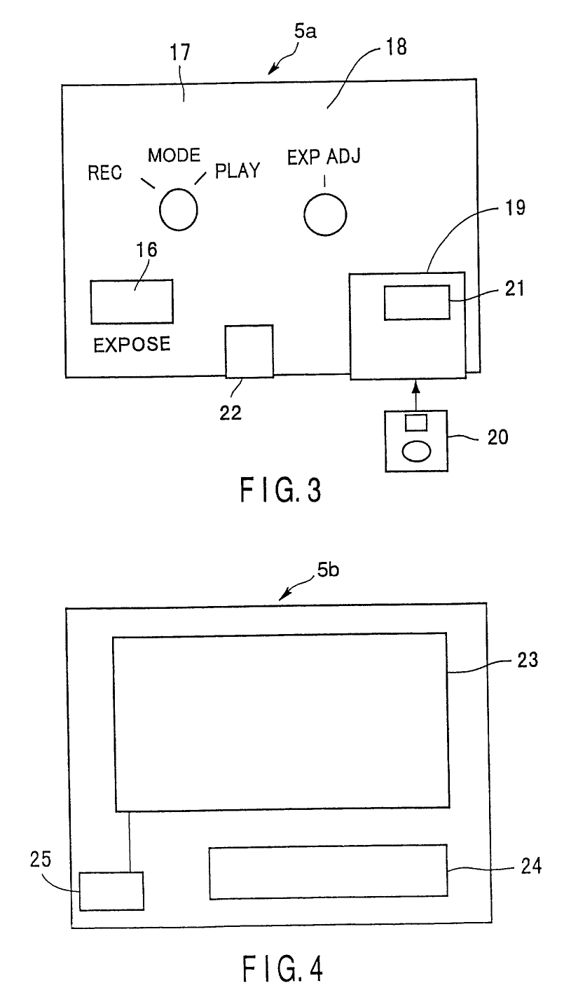

FIG. 3 is a plan view showing the structure of the operation section 5a. The operation section 5a is provided with a shutter SW 16 for performing photographing operation, a mode SW 17 for selecting one from at lest two modes such as “photographing mode (REC)” and “reproducing mode (PLAY)” for reproducing a picked-up image, a exposure correction SW 18 for setting an exposure correction value, and a memory device 19 for storing a picked-up image.

The memory device 19 comprises a removable medium 20 such as a floppy disk widely adopted in computers or the like, and a memory read/write section 21 for writing and reading a photographed image from and into the removable medium 20. The operation section 5a comprises a communication section 22 for remotely controlling each of the SW 16 to 18 provided on the operation section 5a.

FIG. 4 is a block diagram showing the structure of the display section 5b. The display part 5b is provided with an image display panel 23 for displaying a photographed images and reproduced images of images stored in the memory device 19, an information display panel 24 for displaying the exposure time at photographing, photographing information such as an exposure correction or the like, and reproduction information such as an image file name and the like at reproduction, and a D/A converter 25 for converting a digital image signal required to display a digital image on the image display panel 23, into an analogue signal.

In the following, operation of the microscopic imaging apparatus having the structure described above.

A sample image based on the optical system of the microscope body 2 is formed on the photoelectric conversion element 12 through the imaging lens 10 of the imaging apparatus body 1 and is then converted into an electric signal to form an image signal. This image signal is sampled spatially on the basis of time by the sampling circuit 13, and is digitized by the A/D converter 14. Thereafter, predetermined image processing based on the sampling components by the image processing part 15, to generate a reproducible digital image signal of the sample 7. This digital image signal is transmitted to the operation display device 5 via the cable 4 and is converted into an analogue image signal by the D/A converter 25 of the display section 5b and is then displayed on the image display panel 23.

In case of displaying an image on the image display panel 23, an observer can selectively set at least the “photographing mode” and “reproducing mode” by the mode SW 17. If the “photographing mode” is selected, at least the “observation state mode” and “photographing state mode” can be selectively set with respect to the camera head section 3.

If the “photographing mode” is selected by the mode SW 17, the camera head section 3 picks up a dynamic image of the sample 7 on real time and this image is displayed on the image display panel 23, in the “observation state mode”. Alternatively, in the “photographing state mode”, the shutter 11 which is, for example, constructed by a mechanical shutter or an electronic shutter opens and closes in consistence with a proper exposure time, as an observer presses down the shutter SW 16, and a microscopic image (photograph) of the sample 7 in a standstill state is photographed by the camera head section 3. The photographed image at this time is displayed on the image display panel 23, and information such as photographing conditions is displayed on the information display panel 24. Further, the photographed image is recorded and held by the memory device 19.

If the “reproducing model” is selected, a photographed image recorded on the removable medium 20 by the memory device 19 is read through the memory read/write part 21. This photographed image is displayed on the image display panel 23 through the D/A converter 25 of the display section 5b, and reproduction information such as a file name of the reproduced image and the like is displayed on the information display panel 24.

The operation section 5a is not only provided with the shutter SW 16 for performing photographing operation and the mode SW 17 for setting a mode but also provided with various SWs (not shown) for performing desired operation on the camera head section 3 and the display section 5b. The camera head section 3 and the display section 5b perform predetermined operation as the observer operates these SWs.

In addition, the operation section 5a is equipped with a communication part 22, communication between the operation display device 5 and, for example, a personal computer (not shown) is enabled. In this case, the operation display device 5 and the personal computer are directly connected with each other through the communication part 22. In this manner, an image stored in the removable medium 20 in the memory device 19 can be stored into the memory device in the side of the personal computer or can be displayed on the screen in the side of the personal computer. Further, images or the like being displayed on the display section 5b can be displayed on the screen in the side of the personal computer, and photographing operation and reproducing operation executed by the operation section 5a can be controlled from the personal computer.

According to the first embodiment described above, the following advantages are obtained. The camera head section 3 and the operation display device 5 are constructed separately from each other and are connected by the cable 4. Therefore, the operation display device 5 can be set at a position desired by an observer, regardless of the installation position of the camera head section 3. The operation ability in photographing operation for the observer is improved. In addition, the camera head section 3 and the operation display device 5 are separate from each other, so that the camera head section 3 can be downsized and can be easily attached to the microscope body 2.

In addition, by setting the “observation state mode” in the “photographing mode”, the observer can operate the stage 6 of the microscope body 2 while watching the image display panel 23, without looking into the eyepiece 9 of the microscope body 2, so that framing and focusing can be easily achieved with respect to a desired position on the sample image. Also, since it is unnecessary to look into the eyepiece 9, observer's fatigue is reduced. In addition, the observer need not always position himself or herself near the microscope body unlike the conventional apparatus, when the observer carries out photographing operation. Therefore, photographing operation can be achieved more smoothly.

In many cases, the camera head section 3 is set at an upper position of the microscope body 2 or a position distant from an observer. However, the operation display device 5 can be set at a position desired by the observer. Therefore, the observer need not look at, with eyes, or operate the camera head section arranged at a position which the observer can not always easily identify, for the purpose of confirmation on the display about camera operation or framing. Observer's fatigue can thus be reduced during photographing operation. In addition, since the operation section 5a and the display section 5b are integrated with each other, the observer can make various operation and confirmation thereof at one place, so that the photographing operation can be smoothly carried out.

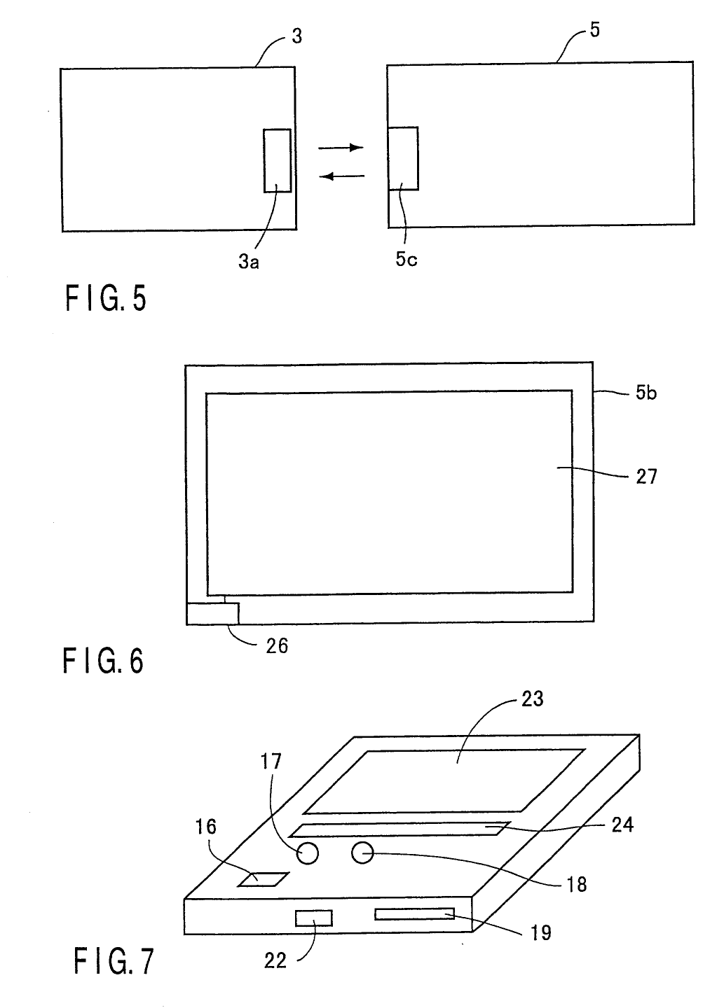

FIG. 5 is a block diagram showing a modification of the camera head section 3 and the operation display device 5 of the first embodiment. In FIG. 5, the camera head section 3 and the operation display device 5 respectively comprise electric signal transmission/reception devices 3a and 5c, in place of connecting the camera head section 3 with the operation display device 5 through the cable 4. The electric signal transmission/reception devices 3a and 5c transmit/receive electric signals to/from each other by wireless communication. By this structure, trouble with the cable 4 is reduced near the microscope body 2 and the operation display device 5. In addition, the setting position of the operation display device 5 can be within an effective range of the wireless communication, so that the degree of freedom concerning the setting position of the operation display device 5 can be improved.

FIG. 6 is a block diagram showing a modification of the display section 5b of the first embodiment. In FIG. 6, the information display panel 24 provided on the display section 5b is omitted, and various information displayed on this information display panel 24 is displayed on the image display panel 27 simultaneously with a photographed image, mixed with an image signal from a D/A converter 25 by an OSD (On Screen Display) generation part 26. By this structure, the information display panel 24 can be reduced from the display panel 5b, so that low costs and space saving can be achieved.

FIG. 7 is a perspective view showing a modification of the operation display device 5 according to the first embodiment. In FIG. 7, the operation section 5a and the display section 5b of the operation display device 5 are installed at 0 degree, and thus, the relative angle therebetween is eliminated to attain flatness. In FIG. 7, the same parts in FIGS. 3 and 4 are denoted at the same reference symbols. By this structure, the occupation volume of the operation display device 5 can be reduced.

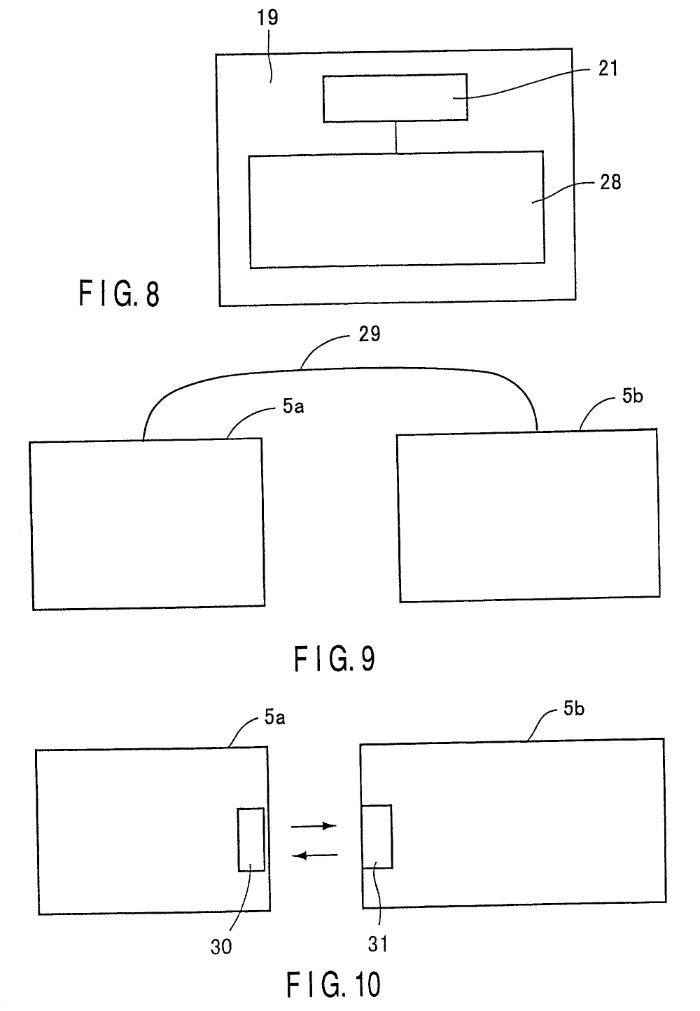

FIG. 8 is a block diagram showing a modification of the memory device 19 according to the first embodiment. In FIG. 8, a fixed memory (internal memory) 28 is installed in the memory device 19, in place of using the removable medium 20, at the operation section 5a shown in FIG. 3. The fixed memory 28 is connected with the memory read/write part 21. This structure saves the operator trouble of preparing a removable medium, so that photographing operation can be carried out more easily.

FIG. 9 is block diagram showing the structure of an operation display device according to the second embodiment of the present invention. In the present second embodiment, the operation section 5a and the display section 5b of the operation display device 5 are constructed as separate components, and are connected with each other by a cable 29. By this structure, display control of the display section 5b is carried out by the operation section 5a through the cable 29.

According to the present second embodiment, the following advantages can be attained in addition to advantages according to the first embodiment. That is, the setting position of the operation section 5a and the display section 5b of the operation display device 5 can be set freely in accordance with the favorites of the observer. In addition, a communication connection with a personal computer or the like is made by the communication part 22 of the operation section 5a. If the function of the display part 5a is substituted by another device like the case of displaying various information and images on the screen of the personal computer, the cable 29 and the display section 5b are not needed. Therefore, the space on the desk can be saved. Further, the electric power consumed by the display section 5b can be reduced, so that electric power saving can be achieved. Further, the functions of the camera head section 3, operation section 5a, and display section 5b are separated from each other, so that a defective part can be easily specified when a malfunction occurs. Note that the operation section 5a can be attachable and detachable to and from the imaging apparatus body 1.

FIG. 10 is a block diagram showing a modification of the operation display device according to the second embodiment. In FIG. 10, the operation section 5a and the display section 5b respectively comprise electric signal transmission/reception devices 30 and 31, in place of connecting the operation section 5a with the display section 5b by the cable 29. The electric signal transmission/reception devices 3a and 5c transmit/receive electric signals to/from each other by wireless communication. By this structure, trouble with the cable 29 is reduced near the operation section 5a and the display section 5b. In addition, the setting position of the display section 5b can be within an effective range of the wireless communication, so that the degree of freedom concerning the setting position of the display section 5b can be improved.

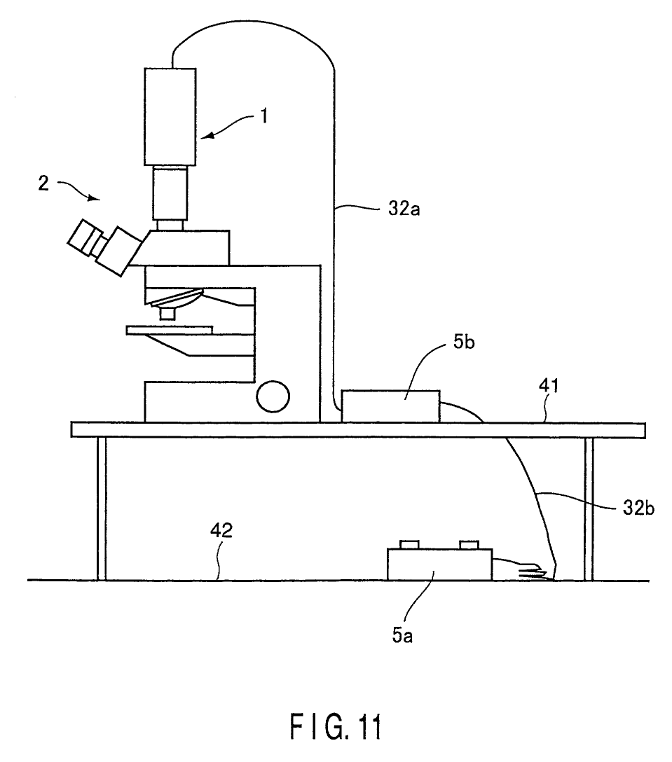

FIG. 11 is a block diagram showing a modification of the operation display device according to the second embodiment. In FIG. 11, the operation section 5a and the display section 5b are connected with each other by a cable 32b. The display section 5b is mounted on a desk 41, and the operation section 5a is set on a floor 42. That is, the operation section 5a is operated by a foot of an observer. Therefore, the shape of the operation section 5a and the layout of switches can be changed such that they can be easily operated by the foot.

Further, the microscope body 2 attached with the imaging apparatus body 1 is mounted on the desk 41, and the imaging body 1 is connected to the display section 5b by the cable 32a. In this structure, space saving of the desk 41 is achieved, and hands of the observer which are conventionally used for operating the operation section 5a can be used for other purposes. Total photographing operation ability is thus improved.

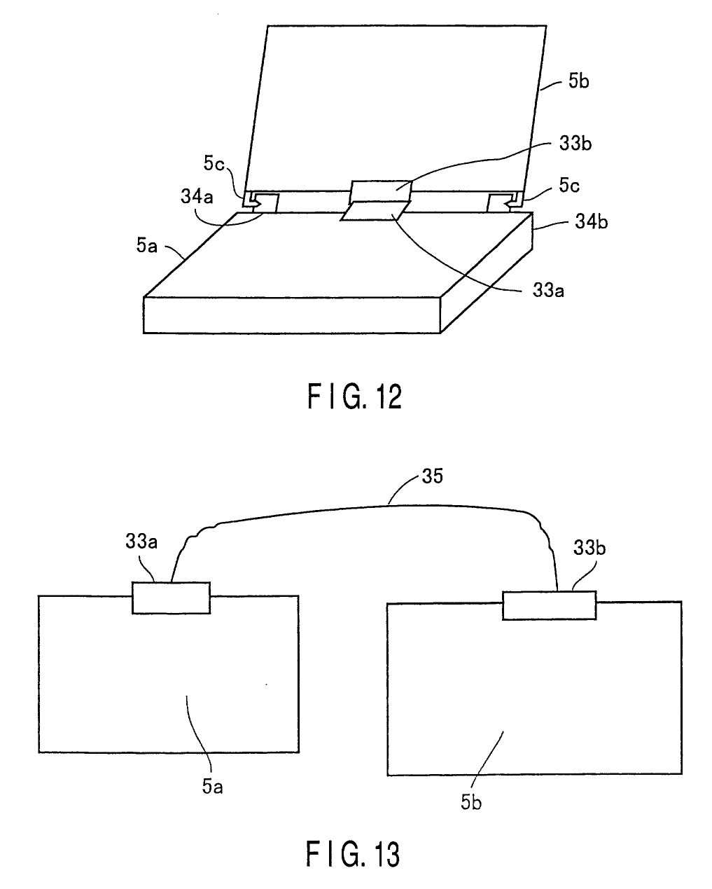

FIG. 12 is a perspective view showing the structure of an operation display device according to the third embodiment of the present invention. The third embodiment is arranged such that the operation section 5a and the display section 5b of the operation display device 5 shown in the first and second embodiments can be attachable and detachable and that the angle at which the operation section 5a and the display section 5b are installed can be adjusted.

In the operation display device 5, the operation section 5a and the display section 5b respectively comprise connection sections 33a and 33b each constructed by a known harness having an electric contact point. These connection sections 33a and 33b can be electrically and mechanically connected with each other, and the operation section 5a and the display section 5b are held attachably and detachably by the connection sections 33a and 33b.

In addition, support sections 34a and 34b are provided in both sides of the connection section 33a, at the rear part of the operation section 5a, and projection sections 5c1 and 5c2 are provided in both sides of the connection sections 33b, at the front part of the display section 5b, so that the installation angle of the display section 5b to the operation part 5a can be adjusted. The projection parts 5c1 and 5c2 are respectively attachable and detachable to and from the support sections 34a and 34b. The projection sections 5c1 and 5c2 are respectively engaged rotatably with the support sections 34a and 34b, so that the display section 5b can be supported at an arbitrary angle by the operation section 5a. Note that the connection sections 33a and 33b are structured such that they can be rotated while maintaining electric connection as the projection sections 5c1 and 5c2 are rotated.

According to the third embodiment, the display section 5b can be set at an angle at which an observer can easily watch the display section by arbitrarily adjusting the angle of the display section 5b in the operation display device 5. Therefore, photographing operation can be carried out easily. In addition, the operation section 5a and the display section 5b can be layered on each other, so that the operation display device 5 is folded compactly and the space on the desk can be used widely in case where only the microscope body 2 is used. Further, refuse, dust, and the like can be prevented from sticking to the image display panel 23 and the information display panel 24 by storing the operation section 5a and the display section 5b layered on each other. Thus, the operation display device 5 has excellent preservability.

FIG. 13 is a block diagram showing a modification of the operation display device according to the third embodiment. In FIG. 13, the operation section 5a and the display section 5b of the operation display device 5 are separated from each other, so that the connection section 33a of the operation section 5a and the connection section 33b of the display section 5b are connected with each other by a cable 35. Therefore, control of the display section 5b by the operation section 5a is carried out through the cable 35. According to this structure, setting positions of the operation section 5a and the display section 5b can be set freely to fit the observer's taste and the space on the desk.

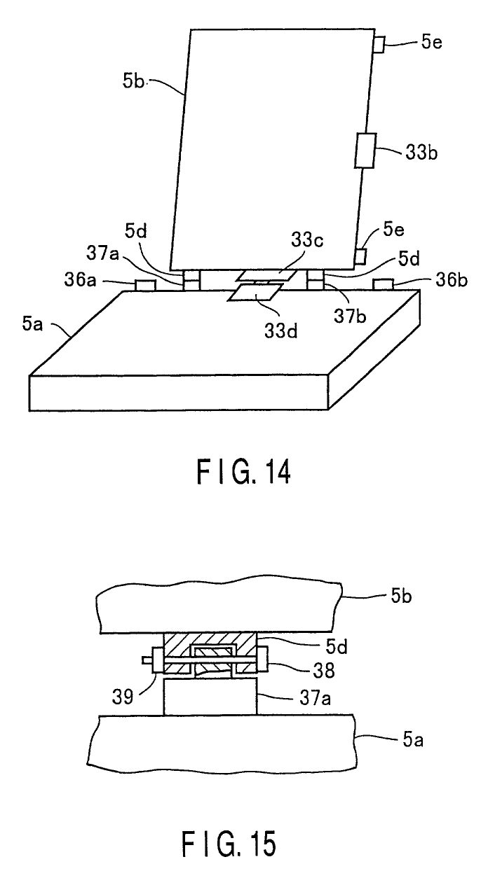

FIG. 14 is a perspective view showing a modification of the operation display device according to the third embodiment. In FIG. 14, support sections 36a and 36b are provided at the rear part of the operation section 5a, and support sections 37a and 37b are provided more inside. In addition, installation sections 5d, 5d are provided at side parts of the display section 5b, and installation sections 5e, 5e are provided at the front part of the display section 5b. A connection section 33c which is the same as the connection section 33b is provided at a side part of the display section 5b.

The installation sections 5d, 5d of the display section 5b are attached to the support sections 37a and 37b of the operation section 5a, thereby to connect the connection sections 33c and 33d with each other. In this manner, the display panel of the display section 5b can be oriented vertically. In addition, the installation sections 5e, 5e of the display section 5b are attached to the support sections 36a and 36b of the operation section 5a, thereby to connect the connection sections 33b and 33d with each other. In this manner, the display panel of the display section 5b can be oriented laterally.

FIG. 15 is a partial cross-sectional view showing the structure of the support section 37a and the installation section 5d shown in FIG. 14. Note that the support sections 36a, 36b, and 37b and the installation part 5e have a similar structure as that shown in FIG. 15. The support section 37a has a convex part provided with a hole which a bolt 38 penetrates, and the installation section 5d also has a concave part provided with a hole which the bolt 38 penetrates. The convex part is engaged with the concave part, and the bolt 38 is inserted in each of the holes of the installation sections 5d and the support section 37a and fixed by a nut 39, so that the display section 5b can be supported at an arbitrary angle to the operation section 5a.

The connection section 33d of the operation section 5a and the connection section 33c of the display section 5b have the same structure as that of the connection sections 33a and 33b shown in FIG. 12. Thus, the sections 33d and 33c construct a structure in which these sections kept connected with each other can be rotated in accordance with rotation of the installation parts 5d, 5d, while maintaining electric connection.

Also, according to the structure described above, the orientation of the display section 5b can be changed. Therefore, if an orientation of a sample image differs from what an observer desires according to the installation direction of the camera head section 3, it is possible to display the sample image on the image display panel, oriented in the direction desired by the observer, by the installation orientation of the camera head section 3. By thus displaying the sample image, the observer can smoothly carry out photographing operation and observation operation.

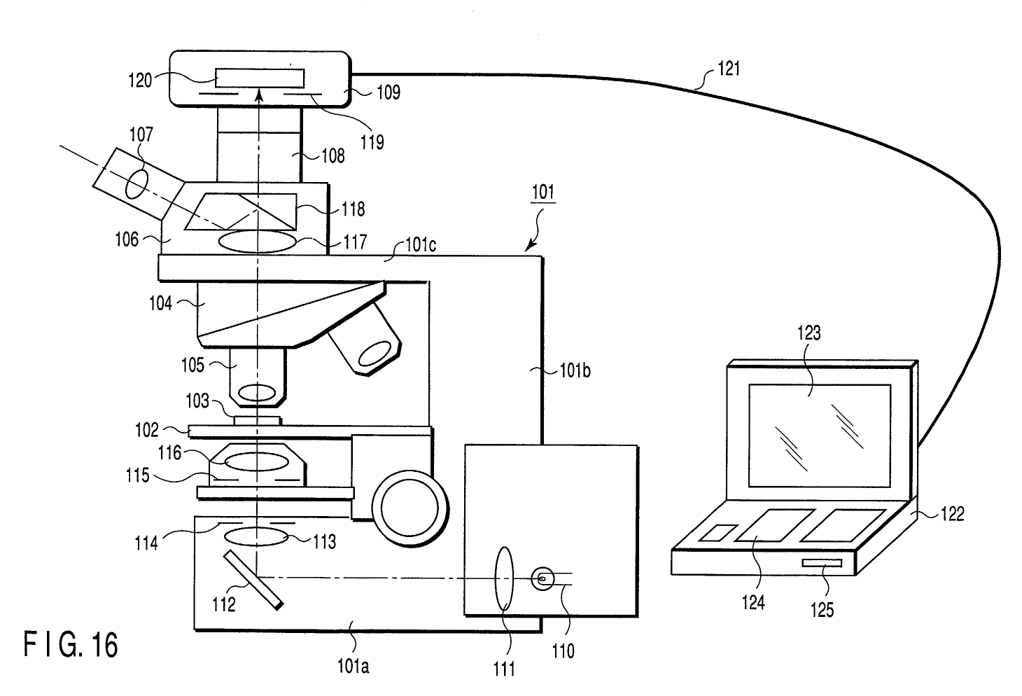

FIG. 16 is a view showing the structure of an imaging apparatus for a microscope (an electronic camera for the microscope), according to the fourth embodiment of the present invention, and the structure of the microscope body to which the electronic camera for the microscope is attached. The microscope body 101 includes a horizontal base section 101a, and a shell section 101b formed to stand to be vertical to the base section 101a. An objective arm 101c parallel to the base section 101a is provided at the top part of the shell section 101b.

The shell section 101b of the microscope body 101 is provided with a stage 102 such that it can move up and down in the optical axis direction of the objective lens 105 described later. A sample 103 is set on the stage 102. In this case, the stage 102 can move up and down in the optical axis direction and can also move in the horizontal direction in a plane vertical to the optical axis.

The objective arm 101c is provided with a revolver 104. This revolver 104 is provided with a plurality of objective lenses 105 so as to oppose to the sample 103 on the stage 102. By rotating operation of the revolver 104, these objective lenses 105 are switched selectively to the optical path. A lens barrel (observation tube) 106 is provided the upper portion of the objective arm 1101c. This lens barrel 106 is provided with an eyepiece 107 and also with a camera head section 109 of an electronic camera for a microscope through a TV adaptor 108.

A transmission light source 110 is provided at a lower part of the shell section 101b of the microscope body 101. Illumination light from the transmission light source 110 enters into the sample 103 from the lower side of the stage 102 through a lens 111, a mirror 112, a lens 113, a filed stop 114, an aperture diaphragm 115, and a condenser lens 116. Also, light flux which has passed through a sample 103 further passes, as a sample image, through an objective lens 105. The image is formed by an imaging lens 117 in the lens barrel 106 and enters into a prism 118. By the prism 118, images diverge from the sample image, and one of the diverging images is emitted though the eyepiece 107, and the other is let enter into the camera head section 109 of the electronic camera for a microscope through the TV adaptor 108.

The camera head section 109 has a shutter 119, an imaging element 120 constructed by a CCD or the like, and an incident sample image is picked up by the imaging element 120 through the shutter 119. The CCD constructing the imaging element 120 has effective pixels 1280×960 (of course, the number of pixels is not limited to this number).

The camera head section 109 is connected with an operation display section 122 through a cable 121. The operation display section 122 has a display section 123, an operation section 124, and a recording medium (memory card) 125. The display section 123 uses a liquid color monitor having display pixels 640×480 (the number of pixels of the liquid color monitor is not limited thereto).

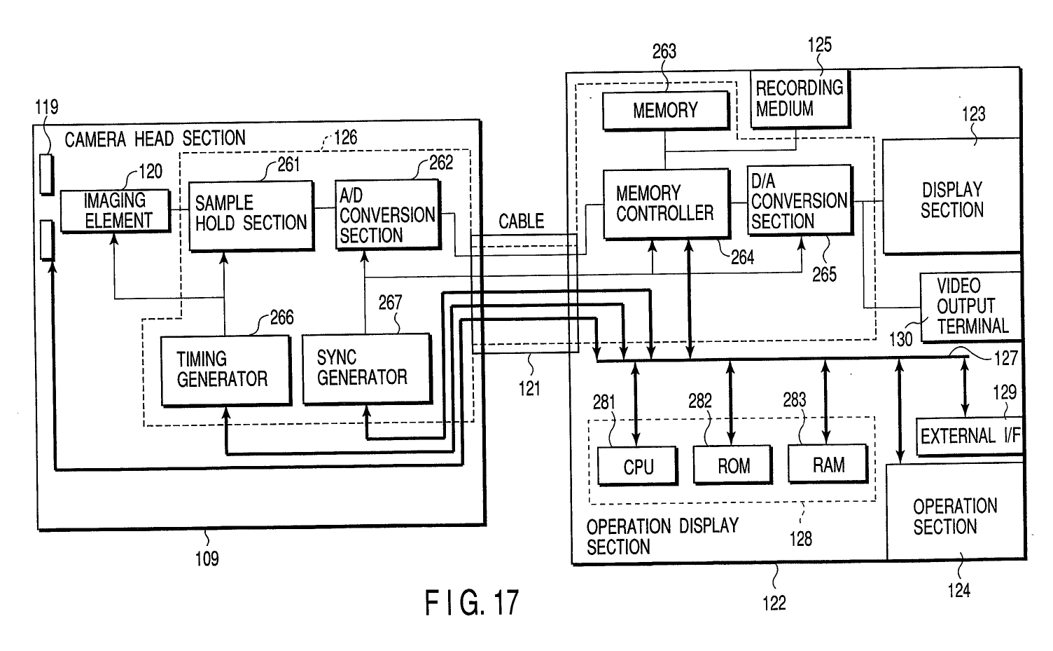

FIG. 17 is a view showing the structure of the camera head section 109 and the operation display section 122 of the electronic camera for a microscope. The camera head section 109 and the operation display section 122 have a signal processing section 126 which processes a signal from the imaging element 120. The signal processing section 126 is connected with a bus line 127 and is controlled by a system control section 128 connected with the bus line 127. Also, the bus line 127 is connected with the operation section 124 described above and an external interface 129.

In the signal processing section 126, a sample hold section 261 for sampling a signal from the imaging element 120, an A/D conversion section 262 for performing A/D conversion, a memory controller 264 for controlling input/output of data to/from a memory which temporally stores image data, and a D/A conversion section 265 for performing D/A conversion are connected in this order. The signal from the imaging element 20 is outputted to the display section 123. Also, the D/A conversion section 265 is connected with a video output terminal 130 which outputs a video signal to the outside, in addition to the display section 123. The same image as that displayed on the display section 123 can be displayed on an external monitor not shown.

A timing generator 266 and a sync generator 267 are connected with a bus line 127, receive an instruction from a system control section 128 through the bus line 127, and output a timing signal. An output signal from the timing generator 266 is inputted to the imaging element 120 and the sample hold section 261, and an output signal from the sync generator 267 is inputted to the A/D conversion section 262, the D/A conversion section 265, and a memory controller 264. Thus, the timing generator 266 controls operation of the imaging element 120 and the sample hold section 261. The sync generator 267 controls the operation of the A/D conversion section 262, D/A conversion section 265, and memory controller 264.

The system control section 128 includes a CPU 281, a ROM 282 including an operation program, and a work RAM 283. The CPU 281, ROM 282, and RAM 283 are also connected with a bus line 127. The CPU 281 performs various control of the electronic camera in accordance with the operation program stored in the ROM 282. The recording medium 125 is connected with the memory 263 and the memory controller 264 and stores and reads image data. Of course, another recording medium than a memory card can be used in place of the recording medium 25.

The operation section 124 is connected with the system control section 128 through the bus line 127, and various operation instructions such as release and the like made by the operation section 124 are transmitted to the system control section 128. The external interface 129 exchanges data with an external personal computer not shown.

In the electronic camera for a microscope which is constructed as described above, the camera head section 109 contains the shutter 119, imaging element 120, sample hold section 261, A/D conversion section 262, timing generator 266, and sync generator 267. Also, the operation display section 122 contains the memory 263, memory controller 264, D/A conversion section 265, display section 123, system control part 128, operation section 124, recording medium 125, external interface 129, and video output terminal 130. The recording medium 125 is constructed such that it can be inserted and detached into/from the operation display section 122. Exchange of image data can be carried out with an external personal computer or the like, through the recording medium 125.

Note that the electronic camera for a microscope, according to the present embodiment, is constructed in a structure the camera head section 109 and the operation display section 122 are separate from each other and are connected with each other by the cable 121 as described above. However, the camera head section 109 and the operation display section 122 can be constructed into an integrated structure, and the layout structure of the electric circuits such as the signal processing part, control section, display section, operation section, and the like is not particularly limited.

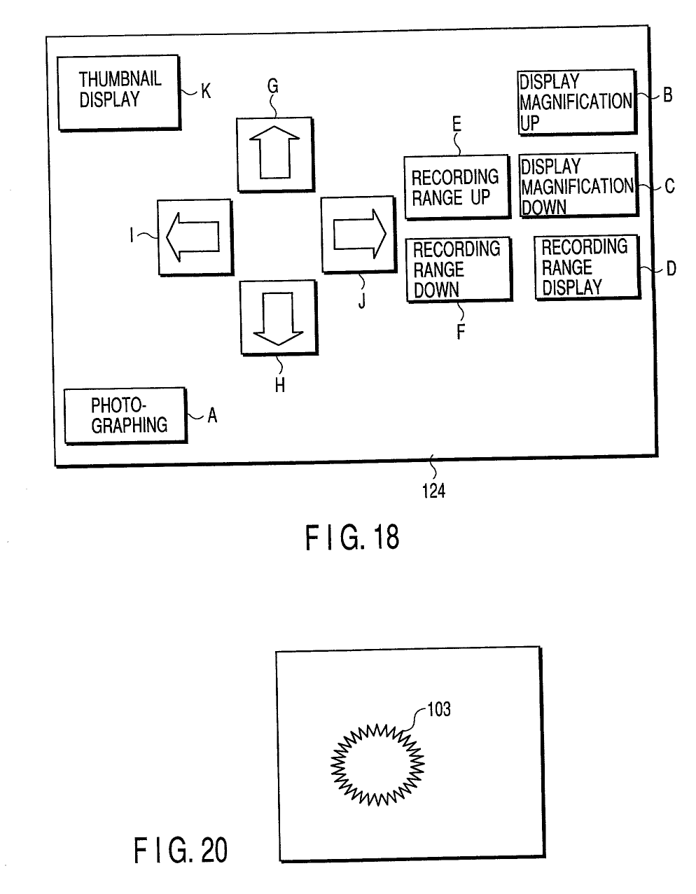

FIG. 18 is a view showing the structure of the operation surface of the operation section 124. A button A is a photographing button for instructing photographing of a still image by means of a shutter 119 and an imaging element 120. Buttons B and C are respectively display magnification up and down buttons for increasing and decreasing the display magnification of a moving image picked up by the imaging element 120 displayed on the display section 123. A button D is a still-image recording range display button for displaying the range where a still image is recorded, on the display section 123. Buttons E and F are respectively still-image recording range up and down buttons for zooming up and down a still image. Buttons G, H, I, and J are respectively a move-up button, a move-down button, a move-left button, and a move-right button for moving the still-image recording range in the upward, downward, leftward, and rightward directions. A button K is an image list display button for executing a function to read one or more image data items recorded on the recording medium 125, prepare minified images thereof, and display them on the display section 123.

In the present fourth embodiment, only the buttons A, B, and C are used and other buttons D, E, F, G, H, I, J, and K are used in the fifth and sixth embodiments described later.

Next, explanation will be made of operations of the electronic camera for the microscope and the microscope body constructed as described above.

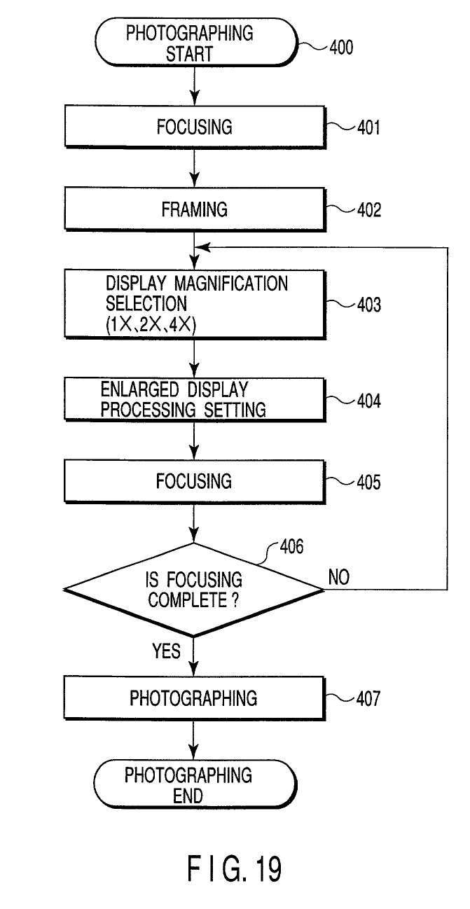

FIG. 19 is a flowchart showing an operation procedure of an electronic camera for a microscope, according to the present fourth embodiment. In the following, the photographing procedure of the electronic camera for the microscope will be explained on the basis of FIG. 19. At first, before the step 400 of starting photographing, an observer sets a sample 103 on a stage 102 in the microscope body 101, completes selection of a magnification of the objective lens 105, and then carries out observation of a sample with eyes through an eyepiece 107.

From this state, the observer turns ON the button A in the step 400, to start photographing. The electronic camera for a microscope photographs a sample image by the imaging element 120, and stores this photographed image as image data of 1280×980 pixels into the memory 263, through the sample hold section 261, A/D conversion section 262, and memory controller 264. The memory controller 264 samples the image data stored in the memory 263, for every other row and for every other column, and displays it as display data of 640×480 pixels on the display section 123 through the D/A conversion section 265. This processing is sequentially repeated, so that the image formed on the imaging element 120 is picked up as a moving image and is displayed on the display section 123.

Next, in a step 401, the observer moves and adjusts the stage 102 in the optical axis direction to adjust the focus, while watching the screen of the display section 123 of the operation display section 122 (focusing). In a step 402, the observer moves and adjusts the stage 102, in a plane vertical to the optical axis to move the photographing position of the sample image to the screen center of the display section 123, while also watching the screen of the display section 123 (framing).

Next, in a step 403, a display magnification is selected on the display section 123. In this case, the display magnification can be selected from three magnifications of one, two, and three times. The selection of the display magnification is carried out by the buttons B and C of the operation section 124. At first, in the initial state, display is performed at the magnification of one time. The setting of the display magnification can be changed to two times from one time by pressing once the button B of the operation section 124, and can further be changed to four times from two times by pressing once more the button B. When the button C is pressed in a state where the display magnification is two or four times, the display magnification is changed to one time from two times or to two times from four times. At the same time when operation of this kind is carried out, the display magnification on the display section 23 is changed in a step 404.

In this case, the followings are the operation states of the electronic camera for a microscope in correspondence with the display magnifications, respectively.

(1) Display magnification is 1 time.

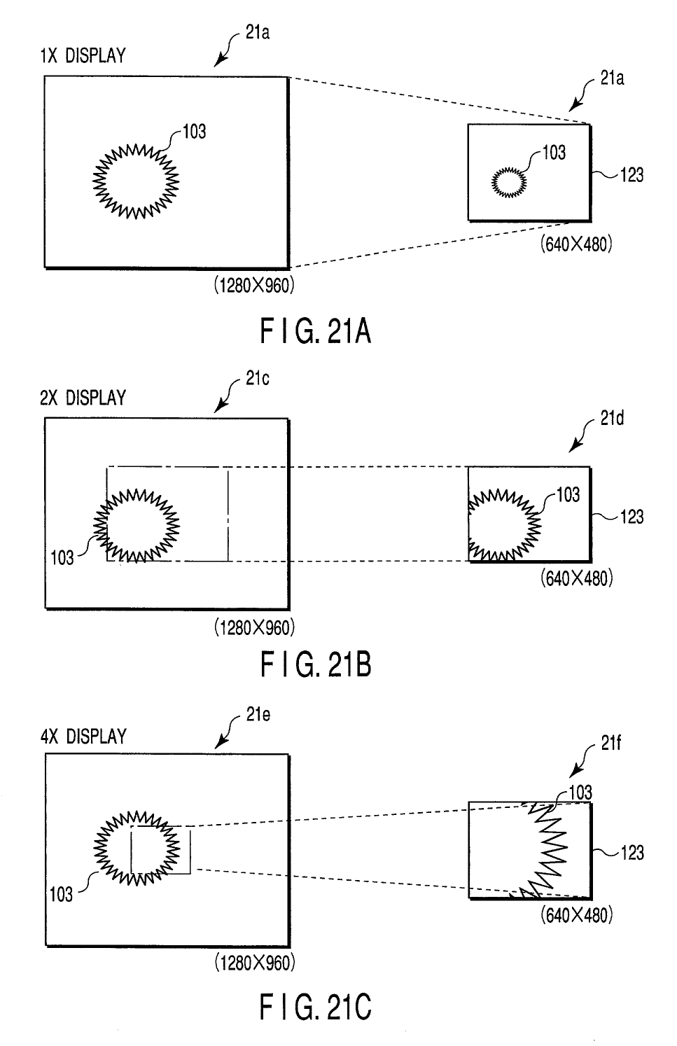

In this case, the electronic camera for a microscope stores an image picked up by the imaging element 120, as image data of 1280×960 pixels as indicated at 21a in FIG. 21A, into the memory 263 through the sample hold section 261, A/D conversion section 262, and memory controller 264. Further, the memory controller 264 samples the image data stored into the memory 263, for every other column and for every other column, and displays the data, as display data of 640×480 pixels as indicated at 21b in FIG. 21A, on the display section 123 through the D/A conversion section 265.

By thus displaying the data, a total image of the sample 103 picked up by the imaging element 120 can be displayed on the display section 123.

(2) The display magnification is two times.

In this case, the electronic camera for a microscope stores an image picked up by the imaging element 120, as image data of 1280×960 pixels as indicated at 21c in FIG. 21B, into the memory 263 through the sample hold section 261, A/D conversion section 262, and memory controller 264. Further, the memory controller 264 samples 640×480 pixels of the center part (surrounded by a one-dot chain line at 21c) of the image data stored into the memory 263, and displays the pixels, as display data of 640×480 pixels as indicated at 21d in FIG. 21B, on the display section 123 through the D/A conversion section 265.

By thus displaying the data, the center part of an image of the sample 103 picked up by the imaging element 120 can be displayed on the display section 123, magnified two times the sample image of the magnification of one time.

(3) The display magnification is four times.

In this case, the electronic camera for a microscope stores an image picked up by the imaging element 120, as image data of 1280×960 pixels as indicated at 21e in FIG. 21C, into the memory 263 through the sample hold section 261, A/D conversion section 262, and memory controller 264. Further, the memory controller 264 samples 320×240 pixels of the center part (surrounded by a one-dot chain line at 21e) of the image data stored into the memory 263. Further, this image data is subjected to pixel compensation and is displayed as display data of 640×480 pixels as indicated at 21f in FIG. 21C, on the display section 23 through the D/A conversion section 265.

By thus displaying the data, the center part of an image of the sample 103 picked up by the imaging element 120 can be displayed on the display section 123, magnified four times the sample image of the magnification of one time.

In a state in which the display magnification on the display section 123 has been changed, the observer performs focusing with high precision again in a step 405. Meanwhile, the display magnification suitable for the focusing varies depending on the sample 103. Therefore, in a next step 406, the observer determines whether the focusing should be completed or tried again when a display magnification is changed. If the focusing should be tried again, the procedure returns to the step 403. Alternatively, if the focusing should be completed, photographing is carried out in a next step 407.

Photographing in the step 407 is carried out as the observer presses the button A of the operation section 24. By pressing the button A, the electronic camera for a microscope picks up a sample image formed on the imaging element 120 in synchronization with open and close operation of the shutter 119, and stores it into the memory 263 through the sample hold section 261, A/D conversion section 262, and memory controller 264. The memory controller 264 controls the memory 263 and the recording medium 25, to record image data of 1280×960 pixels stored in the memory 263, onto the recording medium 125, and the photographing is then completed.

According to the present fourth embodiment, when focus adjustment is carried out while watching the screen of the display section 123, a picked-up part of the sample 103 can be magnified and displayed on the display section 123, so that focus adjustment of the sample image can be carried out more precisely. Also, the image data stored in the recording medium 125 is directly the image data picked up by the imaging element 120. This image data itself cannot be operated by changing the display magnification, and therefore, a high-resolution image can always be recorded.

The structures of an electronic camera for a microscope, according to the fifth embodiment of the present invention, and the microscope body to which the electronic camera is attached are the same as those shown in FIGS. 16 to 18 shown in the fourth embodiment. FIGS. 16 to 18 will be used to the following explanation.

In the fifth embodiment, in the operation section 124 shown in FIG. 18, a button D as a still-image recording range display button for displaying a range where the still image should be recorded on the display section 123, buttons E and F respectively as still image recording range up and down buttons for zooming up and down a still image, buttons G, H, I, and J respectively as move-up button, move-down button, move-left button, and move-right button for moving the still-image recording range in the upward, downward, leftward, and rightward directions are used in addition to the buttons A, B, and C.

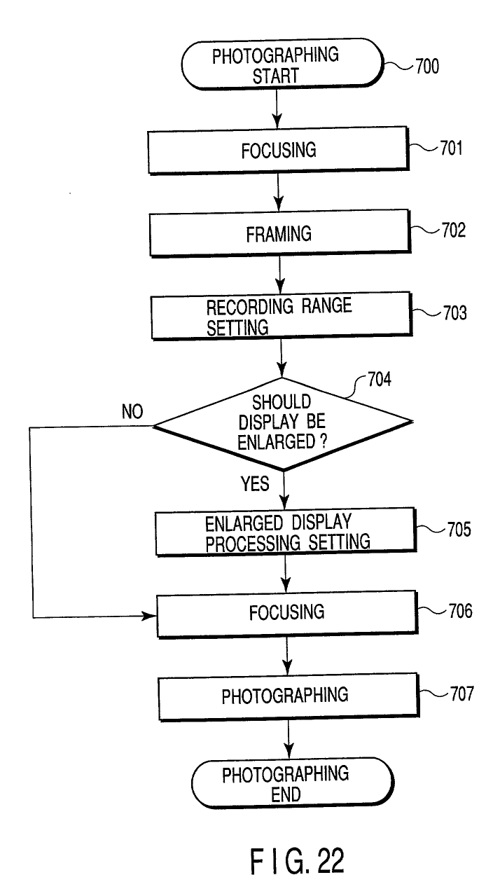

FIG. 22 is a flowchart showing an operation procedure of the above-described electronic camera for a microscope, according to the present fifth embodiment. In the following, the photographing procedure of the electronic camera for a microscope will be explained on the basis of FIG. 22. At first, before the step 700 of starting photographing, an observer sets a sample 103 on a stage 102 in the microscope body 101, completes selection of a magnification of the objective lens 105, and then carries out observation of a sample with eyes through an eyepiece 107.

From this state, the observer turns ON the button A in the step 700, to start photographing. The electronic camera for a microscope photographs a sample image by the imaging element 120, and stores this photographed image as image data of 1280×980 pixels into the memory 263, through the sample hold section 261, A/D conversion section 262, and memory controller 264. The memory controller 264 samples the image data stored in the memory 263, for every other row and for every other column, and displays it as display data of 640×480 pixels on the display section 123 through the D/A conversion section 265. This processing is sequentially repeated, so that the image formed on the imaging element 120 is picked up as a moving image and is displayed on the display section 123.

Next, in a step 701, the observer moves and adjusts the stage 102 in the optical axis direction to adjust the focus, while watching the screen of the display section 123 of the operation display section 122 (focusing). In a step 702, the observer moves and adjusts the stage 102 in a plane vertical to the optical axis to move the photographing position of the sample image to the screen center of the display section 123, while also watching the screen of the display section 123 (framing).

Next, in a step 703, the observer sets a recording range of the still image. The recording range of the still image can be set in three ways of 1280×960 pixels, 640×480 pixels, and 320×240 pixels. The setting of the recording range can be changed by the still image recording range up button E, still image recording range down button F, and move buttons G, H, I, and J. In this case, the still image recording range can be reduced by pressing the button F. That is, when the button F is pressed in the initial state of recording of 1280×960 pixels, the recording range is reduced and changed to recording of 640×480 pixels. When the button F is pressed in the state of recording of 640×480 pixels, the recording range is reduced and changed to recording of 320×240 pixels. When the button E is pressed in the state of recording of 320×240 pixels, the recording range is enlarged and changed to recording of 640×480 pixels. When the button E is further pressed in the state of recording of 640×480 pixels, the recording range is enlarged and changed to recording of 1280×960 pixels. In this step 703, the still image recording range is set by the buttons E and F, and simultaneously, a frame indicating the still image recording range is displayed on the display section 123, in the electronic camera for a microscope.

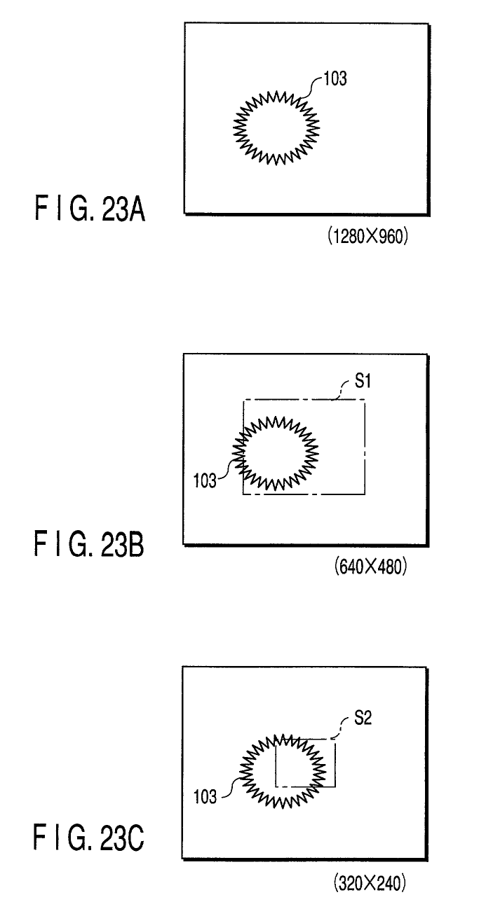

Next, explanation will be made of operation states of the electronic camera for a microscope in correspondence with still image recording ranges. In this case, explanation will be made of a case where a sample 103 shown in FIG. 20 is observed. In corresponding the still image recording range thus set, a rectangular frame S1 or S2 of a one-dot chain line indicating a recording range is displayed as an index on the display section 123, as shown in FIGS. 23B and 23C. The frame S1 or S2 is overlapped on the image data picked up by the imaging element 120 and stored in the memory 263, by the memory controller 264, in accordance with an instruction from the system control section 128 according to the operation of the button E or F, and is displayed on the display section 123 through the D/A conversion section 265.

That is, in FIG. 23A, the still image recording range (1280×960 pixels) is just the size of the image data picked up by the imaging element 120 so that the frame is not displayed. In FIG. 23B, the rectangular frame S1 indicating the recording range of 640×480 is displayed, overlapped on the image data in the memory 263. Further, in FIG. 23C, the rectangular frame S2 indicating the recording range of 320×240 is displayed, overlapped on the image data in the memory 263.

If the still image recording range shown in FIG. 23A is just the image data picked up by the imaging element 120, no change appears on the display screen of the display section 123, so that the still image recording range cannot be identified as being 1280×960 pixels. Therefore, a text of “1280×960” or “FULL” may be displayed on a part of the display section 123 or a LED or the like may be provided at a part of the operation display section 122, to identify the range. Indication of this kind may continue for a predetermined period after a setting change.

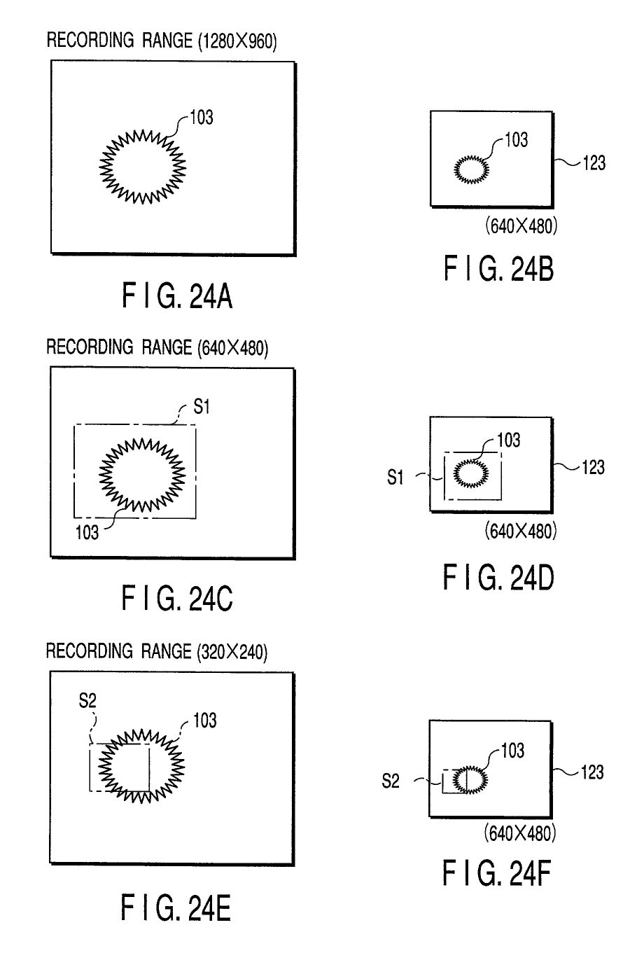

The observer can move the frames S1 and S2 by the move buttons G, H, I, and J while watching the screen of the display section 123. FIGS. 24A and 24B show cases where the recording range is 1280×960 pixels. As shown in FIG. 24A, the entire of image data picked up by the imaging element 120 is displayed directly on the display section 123 as shown in FIG. 24B.

FIGS. 24C and 24D show cases where the recording range is 640×480 pixels. The frame S which has been positioned at the center part in the initial state is moved to a remarked part of the sample 103 by the move buttons G, H, I, and J. That is, FIG. 24C shows image data of 1280×960 pixels in the memory 263, and FIG. 24D shows display data of 640×480 pixels displayed on the display section 123. At this time, in the electronic camera for a microscope, the position of the frame S1 indicating the recording range of 640×480 is moved by the memory controller 264, in accordance with an instruction from the system control section 128 in correspondence with an input from the move buttons G, H, I, and J, and the frame S1 is displayed on the display section 123, overlapped on the sample image.

Further, FIGS. 24E and 24F show cases where the recording range is 320×240 pixels. The frame S2 which has been positioned at the center part in the initial state is moved to a remarked part of the sample 103 by the move buttons G, H, I, and J. That is, FIG. 24E shows image data of 1280×960 pixels in the memory 263, and FIG. 24F shows display data of 640×480 pixels displayed on the display section 123. At this time, in the electronic camera for a microscope, the position of the frame S2 indicating the recording range of 320×240 is moved by the memory controller 264, in accordance with an instruction from the system control section 128 in correspondence with an input from the move buttons G, H, I, and J, and the frame S2 is displayed on the display section 123, overlapped on the sample image.

After the still image recording range is set as described above, the observer determines whether or not the recording range thus set should be enlarged and displayed on the display section 123, in the step 704 shown in FIG. 22. If focusing can be achieved without enlarging the displayed image, the operation goes to the step 706, and the observer carries out focusing. If focusing should be carried out after enlarging the displayed image, the observer sets enlarged-display processing in the step 705.

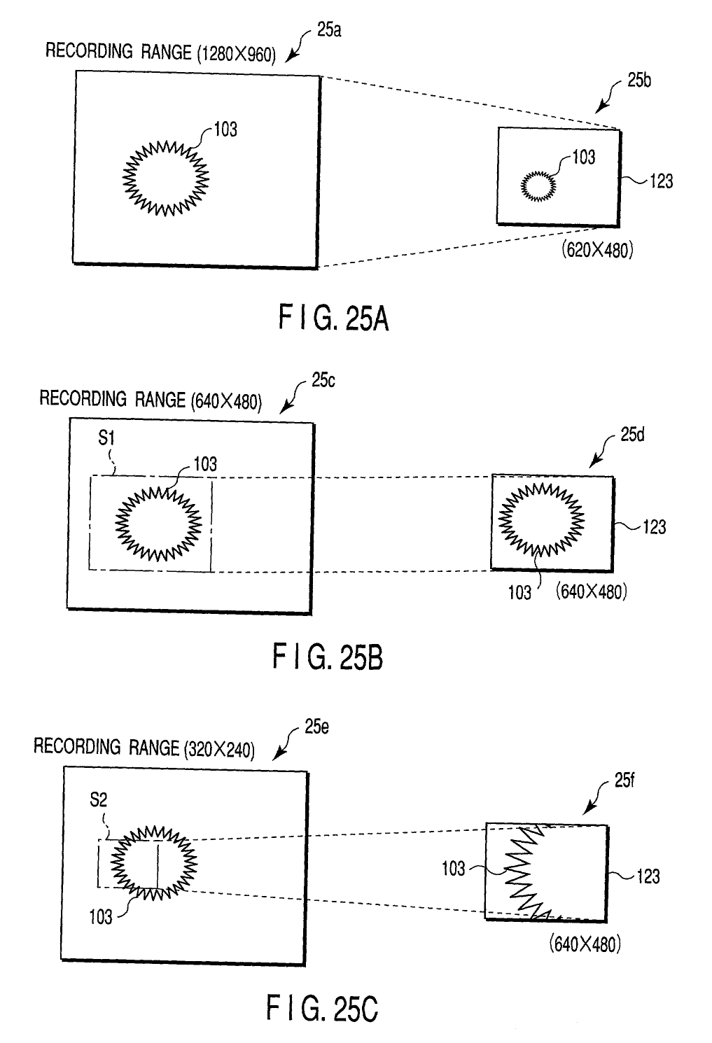

In the step 705, the observer executes setting of the enlarged-display processing by pressing the still-image recording range display button D. If the sill-image recording range is 1280×960 pixels, setting is made such that image data stored in the memory 263, as indicated at 25a in FIG. 25A, is sampled for every other row and for every other column and is displayed as display data of 640×480 pixels, as indicated at 25b in FIG. 25A, on the display section 123 through the D/A conversion section 265. If the still-image recording range is 640×480 pixels, setting is made such that the part surrounded by the frame S1 of 640×480 pixels is directly sampled from the image data stored in the memory 263, as indicated at 25c in FIG. 25B set as described above, and is displayed as display data of 640×480 pixels, as indicated at 25d in FIG. 25B, on the display section 123 through the D/A conversion section 265. Further, if the still-image recording range is 320×240 pixels, setting is made such that the part surrounded by the frame S2 of 320×240 pixels is directly sampled from the image data stored in the memory 263, as indicated at 25e in FIG. 25C set as described above, is converted into display data of 640×480 pixels by interpolation processing, and is thereafter displayed on the display section 123 through the D/A conversion section 265. By performing this setting, the still-image recording range of the sample image based on the microscope is enlarged and displayed as a moving image on the screen of the display section 123.

Next, in the step 706, the observer carries out focusing. After completion of the focusing, photographing is carried out in the step 707. The observer executes this photographing by pressing the button A. By pressing the button A, the electronic camera for a microscope picks up a sample image formed on the imaging element 120 in synchronization with opening/closing operation of the shutter 119 and stores it into the memory 263 through the sample hold section 261, A/D conversion section 262, and memory controller 264. The memory controller 264 controls the memory 263 and the recording medium 125, to record image data of 1280×960 pixels stored into the memory 263 or image data of the part set as a still-image recording range, onto the recording medium 125, and completes the photographing.

According to the present fifth embodiment, a picked-up part of the sample 103 can be enlarged and displayed on the display section 123, when focusing is S carried out while watching the screen of the display section 123. Therefore, focusing on the sample image can be achieved more precisely. In addition, only a remarked part of the sample image can be recorded onto the recording medium 125, the size of the image data to be recorded can be reduced so that the storage capacity of the recording medium 125 can be saved. Thus, more images can be picked up and recorded.

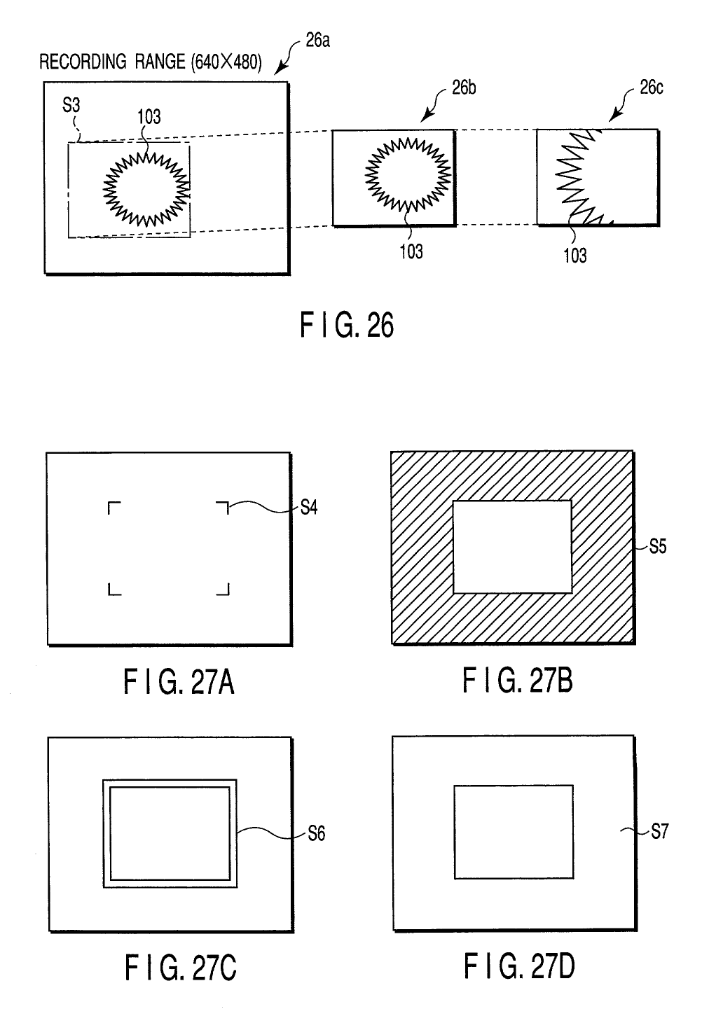

In the fifth embodiment described above, explanation has been made of an example in which a still-image recording range is set and the part is thereafter enlarged and displayed. For example, if the sample 103 is observed as indicated at 26a in FIG. 26, the observer sets a frame S3 as a still-image recording range on an image and presses the still-image recording range display button D similarly to the above, thereby to display the inside of the frame S3 enlarged as indicated at 25b. At this time, if the observer operating the electronic camera for a microscope feels that the magnification is still too low to perform focusing, the display magnification may be enlarged as indicated at 26c, by further pressing the display magnification up button B.

In this manner, the observer can carry out focusing while observing the display at a display magnification suitable for focusing.

In the fifth embodiment described above, the still-image recording range is indicated by the rectangular frame S1 or S2 of one-dot chain line. However, the still-image recording range can be expressed by indications as shown in FIGS. 27A, 27B, 27C, and 27D. FIG. 27A shows a frame S4 which indicates only parts of a frame so that the frame might not hinder observation of a sample. FIG. 27B shows a frame S5 which changes the display method between inside and outside of the frame. Outside the frame S5, display luminance is lowered or monochrome display is adopted. FIG. 27C shows a frame S6 of a double line of white and black lines or yellow and black lines. In this manner, the white or yellow frame can be seen more clearly when the image is dark, while the black frame can be seen more clearly when the image is bright. Accordingly, the frame S6 can be easily viewed regardless of the type of image. FIG. 27D shows a frame S7 which changes colors of the displayed image inside or outside of the frame. For example, conversion processing is performed such that a color set (red, green, and blue: R, G, and B) of original display image data is converted to a color set (255-R, 255-G, and 255-B) within the part of the frame S7 and displayed. In this manner, the still-image recording range can be identified more easily.

The structure of an electronic camera for a microscope, according to the sixth embodiment of the present invention, and the microscope body to which the electronic camera is attached is the same as that shown in FIGS. 16 to 18 described in the fourth embodiment. Therefore, FIGS. 16 to 18 will now be used also for the following explanation. The present sixth embodiment is effective for photographing in the case where one sample has a plurality of remarked areas.

In the present sixth embodiment, the operation part 124 shown in FIG. 18 uses an image list display button K for reading one or more image data items recorded on the recording medium 125 and for preparing minified images thereof, to display them on the display part 123.

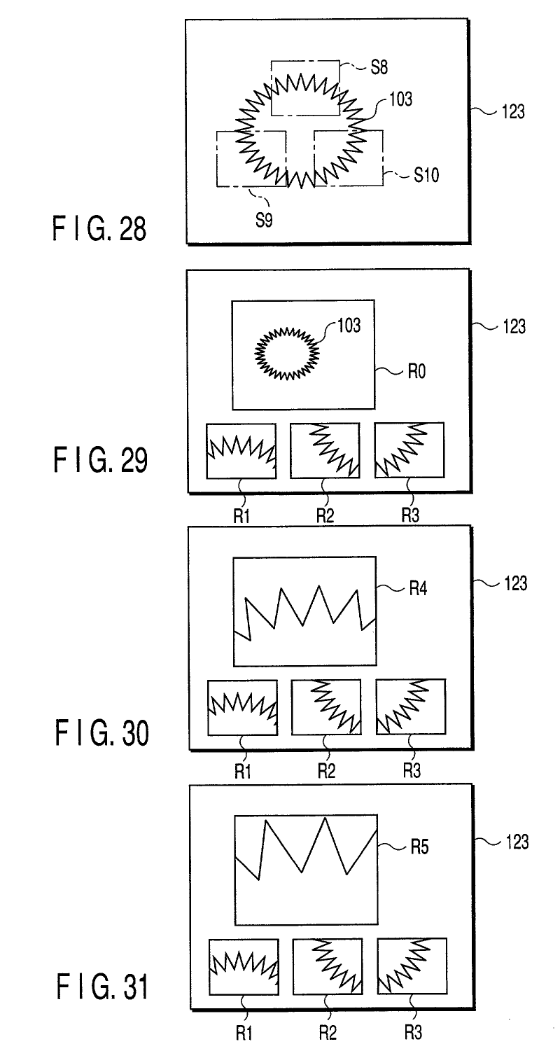

In the following, explanation will be made of a case of photographing a sample 103 observed as shown in FIG. 28 when observation is carried out by an objective lens 105 having a magnification of 10 times. If the parts of rectangular frames S8, S9, and S10 are remarked parts which should be photographed, the resolution of images will be deteriorated by the method described in the fifth embodiment in which only these remarkable parts are photographed as recording ranges. To achieve photographing at high resolution, photographing may be carried out with a raised magnification with respect to each remarked part. In many cases, however, the shapes of remarkable parts are similar to each other in case of a sample such as a cell or the like. If photographing is carried out by merely raising the magnification, it is difficult to adjust the position at an equal position in a state where the magnification is high.

Hence, in the present sixth embodiment, photographing is carried out with only remarked areas set as recording ranges each including 320×240 pixels, with use of an objective lens 105 having a low magnification. Images of these areas are displayed in a list on a part of the display section 123. Further, the observer increases the magnification of the objective lens 105 and carries out precisely positioning to the same remarked areas, while watching the displayed list of images.

Explanation will now be made of the operation of the electronic camera for a microscope at this time. At first, the observer switches the objective lens 105 to a lens having a magnification of 10 times, and a sample image based on the microscope is displayed on the display section 123 as shown in FIG. 28. Next, in the procedure explained in the fifth embodiment, the rectangular frames S8, S9, and S10 as remarked areas are photographed as recording image ranges each including 320×240 pixels, and image data items thereof are recorded onto the recording medium 125.

Next, the observer presses the image list display button K of the operation section 124. As the image list display button K is pressed, image list display is set in the electronic camera for a microscope. That is, in response to an input instruction at the image list display button K, the system control section 128 reads images each having 320×240 pixels inside the frames S8, S9, and S10 as remarked areas stored in the recording medium 25, into the memory 263 by the memory controller 264. Further, these images are re-sampled thereby to obtain minified images each having 160×120 pixels. Further, as shown in FIG. 29, minified images R1, R2, and R3 are displayed, listed in line at a lower part of the screen of the display section 123, by the system control section 128. At this time, a total image R0 having 320×240 pixels, which is prepared by sampling the image data of 1280×960 pixels picked up by the imaging element 120 and stored in the memory 263, for every third row and for every third column, is displayed at an upper part of the screen of the display section 123.

Next, the observer switches the objective lens 105 to a lens of magnification of 40 imes and carries out positioning of a remarked area by operating the stage 102, while referring to the minified images R1, R2, and R3 displayed in a list at the lower part of the screen of the display section 123. At this time, as shown in FIG. 30, a moving image R4 of the sample 103 which is enlarged by the switching of the objective lens is displayed at the upper part of the screen of the display section 123. Further, the observer presses the display magnification up button B to enlarge the moving image of the sample 103 displayed at the upper part of the display section 123. At this time, the electronic camera for a microscope re-samples the area of 640×480 pixels at the center part of the image of 1280×960 pixels picked up by the imaging element 120 and stored into the memory 263, by means of the memory controller 264. In this manner, an enlarge image R5 having 320×240 pixels is displayed at the upper part of the screen of the display section 123, as shown in FIG. 31.

In this state, the observer carries out focusing so that the display area of the moving image is narrowed while focusing can be achieved with high resolution. After completion of the focusing, the observer presses the photographing button A to carry out photographing. In this case, as the button A is pressed, the electronic camera for a microscope picks up a sample image formed on the imaging element 120 in synchronization with open and close operation of the shutter 119, and stores it into the memory 263 through the sample hold section 261, A/D conversion section 262, and memory controller 264. The memory controller 264 controls the memory 263 and the recording medium 125, to record image data of 1280×960 pixels stored in the memory 263, onto the recording medium 125, and the photographing is then completed. By performing similar photographing on each of the frames S8, S9, and S10 of remarked areas, the each remarked area can be photographed with high-resolution of 1280×960 pixels.

According to the present sixth embodiment, positioning can be carried out precisely on a plurality of remarked parts on a sample image and focusing can be achieved with high precision, so that photographing at high-resolution can be realized.

In the sixth embodiment described above, the interior of the frames S8, S9, and S10 is captured orderly in the procedure according to the fifth embodiment. The following embodiment can be considered. An electronic camera for a microscope displays remarked areas shown in FIG. 28, as recording image ranges, on the display section 123. That is, a plurality of recording image ranges can be set and displayed. Further, the electronic camera for a microscope photographs simultaneously a plurality of ranges thus specified, and records them onto a recording medium 125. At this time, the ranges need not always be recorded on the recording medium 125 but may be directly stored in a list image display area in the memory controller 264. According to this modification, the same advantages as those of the sixth embodiment described above can be attained.

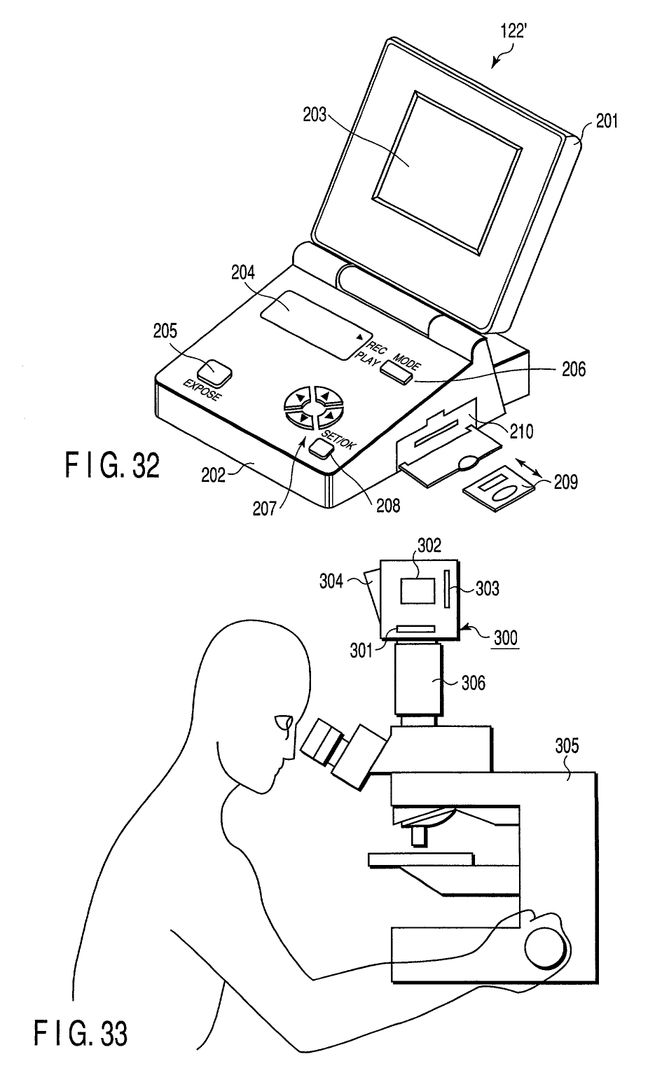

FIG. 32 is a perspective view showing a modification of the operation display device 5 shown in FIG. 1 and the operation display section 122 shown in FIG. 16. An operation display section 122′ shown in FIG. 32 is comprised of a monitor section 201 and a base section 202, and the monitor section 201 is rotatably connected with the base section 202.

Therefore, the angle of the monitor section 201 to the base section 202 can be changed freely, so that the monitor section 201 can be folded toward the front side. The monitor section 201 is provided with an image display panel 203 for displaying a photographed image and a reproduced image.

An information display panel 204 and various operation switches are arranged on the upper surface of the base section 202. The information display panel 204 displays various operation information of the electronic camera for a microscope and photographing information (including photographing information such as type of current operation mode, operation menu, exposure time at photographing, exposure correction, and the like, and reproducing information such as an image file name at photographing and the like). Also, a shutter SW 205, a mode SW 206, arrow keys 207, and a SET/OK-SW 208 are provided as operation switches. The functions of the shutter SW 205 and the mode SW 206 are the same as those described in the first embodiment.

The arrow keys 207 are four keys corresponding to four directions, i.e., upward, downward, leftward, and rightward directions, respectively. The arrow keys 207 are used for selection operation on an operation menu displayed on the information display panel 204, moving operation of a frame indicating a recording range on an image displayed on the image display panel 203, selection operation of a display magnification, and the like. The SET/OK-Sw 208 is pressed down to enter a position or magnification of a menu or frame selected by the operation as described above.

An insertion slot 210 for a removable medium 209 for recording image data is provided in the right side surface of the base section 202. A floppy disk or memory card can be used as the removable medium 209.

In the operation display device 5 shown in FIG. 1 and the operation display section 122 shown in FIG. 16, various operation information and photographing information are displayed on the display section (5b or 123) positioned apart from the various operation switches. In contrast, the operation display section 122′ shown in FIG. 32 displays these information items on the information display panel 204 positioned close to the various operation switches, so that operation ability is improved.

The operation display section 122′ is applicable to the imaging device explained in the fourth embodiment. In this case, the display magnification of the image displayed on the image display panel 203 is changed by operating the upward and downward arrow keys of the arrow keys 207. When the shutter SW 205 is operated, photographing of an image is carried out. At the time of this photographing, the image data obtained by the imaging apparatus body is recorded directly onto the removable medium 209, regardless of the display magnification on the image display panel 203. Alternatively, the contents explained in the fourth, fifth, and sixth embodiments are applicable to this modification.

According to the present invention, the imaging apparatus body (camera body) and the display section are separate from each other. Therefore, regardless of the installation position of the imaging apparatus body, display can be checked, photographing operation can be carried out smoothly, and the photographing operation ability for the observer can be improved. Also, according to the present invention, the operation section and the display section of the operation display device are integrated with each other. Therefore, the observer can carry out photographing operation and display check thereof can be carried out simultaneously, so that concentrated operation can be carried out for photographing and the photographing operation can be carried out without stress.

According to the present invention, the operation section and the display section of the operation display device is separate from the imaging apparatus body. Therefore, if the imaging apparatus body is distant from the observer, the operation section and display section can be set near the observer. That is, regardless of the position of the imaging apparatus, the operation section and the display section can be set at a favorite position of the observer. As a result, the observer can carry out concentrated operation with respect to photographing and can carry out smoothly photographing operation without stress. In addition, the observer need not always position himself or herself near the imaging apparatus body or a microscope. Therefore, the installation positions of the microscope and the imaging apparatus body need not be changed in accordance with the position of the observer. As a result, the observer can carry out concentrated operation with respect to photographing and can carry out smoothly photographing operation without stress. Further, the imaging apparatus body can be downsized.

According to the present invention, the operation section of the operation display device is attachable and detachable to and from the display section or the imaging apparatus body. Therefore, if it is attached, a wide work space can be maintained on the desk. If it is detached, the operation section can be arranged at a position desired by the operator, so that photographing operation can be carried out without stress. According to the present invention, the observer can adjust the display part of the operation display device to a desired angle, so that the display can be easily checked and the photographing operation can be carried out smoothly without stress.

According to the present invention, the imaging apparatus body and the display part are electrically connected to each other by a cable or the like, so that the imaging apparatus body can be operated on real time. In this manner, the imaging apparatus body is set on the microscope, so that the display part and the operation part can be set at a different place, while maintaining their electric connection with the imaging apparatus body. Therefore, regardless of the positions of the imaging apparatus and the microscope, the observer can set the display part and the operation part at positions where handling is easy, and can carry out concentrated photographing operation and display check.

According to the present invention, focusing can be easily carried out by enlarging a part at remarked position on a sample. Even when photographing is carried out with the display magnification changed, the image data is not operated by the change of the display magnification. Therefore, a high-resolution image can be constantly recorded.

According to the present invention, only a remarked part of a sample image can be recorded onto a recording medium. Therefore, the scale of image data to be recorded can be reduced, so that the storage capacity of the recording medium can be saved and more images can be photographed and recorded. According to the present invention, image areas which require change of the display magnification can be displayed on the display section. It is therefore possible to set easily a remarked part of a sample to be saved. According to the present invention, focusing can be carried out while positioning precisely a plurality of remarked parts on a sample image. Therefore, photographing at high resolution can be realized. That is, according to the present invention, it is possible to provide an imaging apparatus for a microscope, which is capable of performing focusing and framing at high precision.

As has been explained above, according to the present invention, it is possible to provide an imaging apparatus for a microscope, which improves operation ability at photographing.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An imaging apparatus for a microscope, comprising:
an imaging section which picks up an observation image of a sample formed in a microscope body;
an imaging apparatus body having the imaging section;
a display section which displays image data corresponding to the observation image picked up by the imaging section; and
an operation section which performs operation of the imaging section, wherein
the imaging apparatus body and the display section are separate from each other.

2. The imaging apparatus for a microscope according to claim 1, wherein
the operation section is attached to the display section, and
an angle of the display section to the operation section is adjustable.

3. The imaging apparatus for a microscope according to claim 1, further comprising:
a storage section which stores image data corresponding to the observation image picked up by the imaging section, wherein
the display section displays the image data stored in the storage section,
the operation section which designates a display magnification of the image data stored in the storage section,
in accordance with a designation made by the operation section, a partial area of the image data is displayed on the display section, enlarged at the display magnification, and
an attachable and detachable recording medium for recording entire of the image data stored in the storage section.

4. The imaging apparatus for a microscope according to claim 3, wherein the partial area displayed and enlarged is a center part of the image data.

5. The imaging apparatus for a microscope according to claim 3, wherein
the operation section instructs position adjustment in the image data of the area enlarged and displayed, and
the control section moves the area enlarged and displayed, within the image data, in accordance with an instruction made by the operation section.

6. The imaging apparatus for a microscope according to claim 5, wherein the control section displays an index indicating the predetermined area, on the display section.

7. The imaging apparatus for a microscope according to claim 3, further comprising a recording medium which records at least a part of the image data stored in the storage section.

8. The imaging apparatus for a microscope according to claim 7, wherein the control section reads at least one image recorded on the recording medium and displays the image on the display section, minified in a list.

9. The imaging apparatus for a microscope according to claim 3, wherein
the operation section sets the plurality of predetermined areas within the image area, and
the control section displays images of the predetermined areas, at the display magnification, in a list, on the display section.

10. The imaging apparatus for a microscope according to claim 1, wherein
the operation section is integrated with one of the imaging apparatus body and the display section.

11. The imaging apparatus for a microscope according to claim 1, wherein the operation section is separate from the imaging apparatus body and the display section.

12. The apparatus according to claim 1, wherein the operation section is attachable to and detachable from one of the imaging apparatus body and the display section.

13. The imaging apparatus for a microscope according to claim 1, wherein the operation section transmits contents of inputted operation by an electric signal to the imaging apparatus body.

14. The imaging apparatus for a microscope according to claim 1, wherein the operation section transmits contents of inputted operation by an electric signal to the display section.

15. An imaging apparatus for a microscope, comprising:
an imaging section which picks up an observation image of a sample formed in a microscope body;
a storage section which stores image data corresponding to the observation image picked up by the imaging section;
a display section which displays the image data stored in the storage section;
an operation section which designates a display magnification of the image data stored in the storage section; and
a control section which displays a partial area of the image data, at the display magnification, in accordance with a designation made by the operation section.

16. The imaging apparatus for a microscope according to claim 15, wherein the partial area is a center part of the image data.

17. The imaging apparatus for a microscope according to claim 15, wherein
the operation section instructs position adjustment of the partial area within the image data, and
the control section moves the partial area within the image data, in accordance with an instruction made by the operation section.

18. The imaging apparatus for a microscope according to claim 15, further comprising a recording medium which records at least a part of the image data stored in the storage section.

19. The imaging apparatus for a microscope according to claim 17, wherein the control section displays an index indicating the predetermined area, on the display section.

20. The imaging apparatus for a microscope according to claim 18, wherein the control section reads at least one image recorded on the recording medium and displays the image on the display part, minified in a list.

21. The imaging apparatus for a microscope according to claim 15, wherein
the operation section sets a plurality of the predetermined areas within the image area, and
the control section displays images of the predetermined areas, at the display magnification, in a list on the display section.
